(19) United States
(12) Patent Application Publication
(10) Pub. No.: US 2025/0068721 A1
(43) Pub. Date: Feb. 27, 2025

(54) DEVICE HOTPLUG METHOD, COMPUTER DEVICE, AND STORAGE MEDIUM

(71) Applicant: Beijing Volcano Engine Technology Co., Ltd., Beijing (CN)

(72) Inventor: Liang ZHOU, Beijing (CN)

(21) Appl. No.: 18/793,730

(22) Filed: Aug. 2, 2024

(30) Foreign Application Priority Data
Aug. 25, 2023 (CN) 202311088288.8

(51) Int. Cl. G06F 21/53; G06F 9/455

(52) U.S. Cl. CPC G06F 21/53; G06F 9/45558; G06F 2009/45587; G06F 2221/034

(57) ABSTRACT

Provided are a device hot-plug method, a computer device, and a storage medium. The method includes: in response to a hotplug request received by a virtual machine monitor for a virtual target device in a virtual machine, determining operation resource information corresponding to the hotplug request using the virtual machine monitor, where the operation resource information includes resource information needed for performing hotplug on the virtual target device; storing the operation resource information to an operation queue of a preset hotplug device, and sending an interrupt trigger signal to a sub-operating system of the virtual machine; and acquiring the operation resource information from the operation queue by using the sub-operating system when the interrupt trigger signal is detected by the sub-operating system, and executing a hotplug operation for the virtual target device according to the operation resource information.

### CROSS-REFERENCE TO RELATED APPLICATIONS

This application claims the priority of Chinese Patent Application No. 202311088288.8 filed on Aug. 25, 2023, and the disclosure of this application is incorporated by reference herein in its entirety as part of the present application.

### TECHNICAL FIELD

The present disclosure relates to a device hotplug method, a computer device, and a storage medium.

### BACKGROUND

In order to solve the security issue of platform as a service (PaaS), a secure container scheme based on virtualization technology is usually adopted. Secure containers can be isolated from each other using the underlying hardware-assisted virtualization technology, thus ensuring independent operation of the virtual machine in each container.

In the PaaS scenario, device hotplug for virtual machine in the secure container is a common virtual machine processing demand. The conventional device hotplug mode is implemented based on Advanced Configuration Power Interface (ACPI) mechanism and Peripheral Component Interconnect (PCI) mechanism using Virtual Machine Monitor (VMM) and a sub-operating system in the secure container. However, there are great disadvantages in the device hotplug mode using the ACPI and PCI mechanisms, which not only slows down the startup speed of the virtual machine, but also increases the security risks of the virtual machine.

### SUMMARY

An embodiment of the present disclosure at least provides a device hotplug method and apparatus, a computer device, and a storage medium.

An embodiment of the present disclosure provides a device hotplug method, including:
in response to a hotplug request received by a virtual machine monitor for a virtual target device in a virtual machine, determining operation resource information corresponding to the hotplug request using the virtual machine monitor, wherein the operation resource information includes resource information needed for performing hotplug on the virtual target device;
storing the operation resource information into an operation queue of a preset hotplug device, and sending an interrupt trigger signal to a sub-operating system of the virtual machine, wherein the preset hotplug device is an information transmission channel between the virtual machine monitor and the sub-operating system, and is configured to transmit information related to the hotplug request; and
acquiring the operation resource information from the operation queue by using the sub-operating system when the interrupt trigger signal is detected by the sub-operating system, and executing a hotplug operation for the virtual target device according to the operation resource information.

In one possible implementation, receiving the hotplug request for a virtual target device in a virtual machine includes:
receiving a container request for a secure container, wherein the container request is used to instruct to execute the hotplug operation on the virtual target device in a virtual machine in the secure container;
converting the container request into the hotplug request matched with the virtual machine monitor; and
determining a target interface related to the virtual target device from a plurality of application programming interfaces developed for the virtual machine monitor, and calling the target interface to send the hotplug request to the virtual machine monitor.

In one possible implementation, the determining operation resource information corresponding to the hotplug request using the virtual machine monitor includes:
establishing communication connection with the virtual target device, and determining a resource feature structure supported by the virtual target device using the communication connection; and
configuring the operation resource information for the virtual target device according to the hotplug request and the resource feature structure.

In one possible implementation, prior to determining operation resource information corresponding to the hotplug request using the virtual machine monitor, the method further includes:
starting the secure container in response to a container startup request, and initializing the virtual machine monitor and the sub-operating system; and
starting the preset hotplug device deployed in the virtual machine monitor in a process of initializing the virtual machine monitor.

In one possible implementation, initializing the sub-operating system includes:
starting a hotplug thread of the sub-operating system and setting the hot-plug thread to a dormant state;
setting a trigger mechanism for the hotplug thread, wherein the trigger mechanism is used to awake the hotplug thread in the dormant state when the interrupt trigger signal is detected, and the hotplug thread is used to execute the hotplug operation for the virtual target device according to the operation resource information.

In one possible implementation, when the virtual target device includes a virtual central processing unit in the virtual machine, the operation resource information includes a number of the virtual central processing units and an operation type of the hotplug operation; and

when the virtual target device includes any virtual device in the virtual machine, the operation resource information includes address information of the virtual device, length information corresponding to the virtual device, interrupt information corresponding to the virtual device, and the operation type of the hotplug operation.

In one possible implementation, the executing a hotplug operation for the virtual target device according to the operation resource information includes:
determining operation logic according to an operation type indicated by the operation resource information and a device type of the virtual target device; and
executing the hotplug operation corresponding to the operation type for the virtual target device according to the operation logic and the operation resource information.

An embodiment of the present disclosure also provides a device hotplug apparatus including a determining module, a storage module and an execution module.
the determining module is configured to, in response to a hotplug request received by a virtual machine monitor for a virtual target device in a virtual machine, determine operation resource information corresponding to the hotplug request using the virtual machine monitor, wherein the operation resource information includes resource information needed for performing hotplug on the virtual target device;
the storage module is configured to store the operation resource information into an operation queue of a preset hotplug device, and send an interrupt trigger signal to a sub-operating system of the virtual machine, wherein the preset hotplug device is an information transmission channel between the virtual machine monitor and the sub-operating system, and is configured to transmit information related to the hotplug request; and
the execution module is configured to acquire the operation resource information from the operation queue by using the sub-operating system when the interrupt trigger signal is detected by the sub-operating system, and execute a hotplug operation for the virtual target device according to the operation resource information.

An optional implementation of the present disclosure also provide a computer device, including a processor, and a memory, wherein a machine readable instruction capable of being executed by the processor is stored in the memory, the processor is configured to execute the machine readable instruction stored in the memory, and when the machine readable instruction is executed by the processor, the processor executes the device hotplug method described above.

An optional implementation of the present disclosure also provide a computer readable storage medium, wherein a computer program is stored on the computer readable storage medium, and when the computer program is run by a computer device, the computer device executes the device hotplug method described above.

The description of the effects of the device hot-plug apparatus, the computer device and a computer readable storage medium may refer to the description of the device hotplug method above, which will not be repeated in detail here.

According to the device hotplug method and apparatus, the computer device and the storage medium provided by the embodiment of the present disclosure, after receiving a hotplug request, a virtual machine monitor (hereinafter referred to as VMM) can be configured to accurately determine operation resource information required by the hot-plug request. A sub-operating system can be timely informed in a way sending the operation resource information to an operation queue corresponding to a developed preset hotplug device and then sending an interrupt trigger signal, then the sub-operating system can be configured to acquire the operation resource information from the operation queue, and hotplug for the virtual target device in the virtual machine can be achieved according to the operation resource information. The whole hotplug process can be achieved by the VMM and the sub-operating system based on the preset hotplug device and the operation queue without using an ACPI mechanism and a PCI mechanism. Because the implementation of the preset hot-plug device is lighter than the ACPI mechanism and the PCI mechanism, hotplug by the preset hot-plug device can effectively reduce the implementation number of lines of code. The reduction of the lines of code not only can effectively avoid the problem of slowing down the startup speed of the virtual machine, but also can greatly reduce the possibility that the VMM and the sub-operating system are invaded, thus reducing running risk of the virtual machine, and improving running security of the virtual machine.

In order to make the objectives, features and advantages of the present disclosure more clearly, the following is a detailed description of preferred embodiments with reference to the accompanying drawings.

### BRIEF DESCRIPTION OF DRAWINGS

In order to describe the technical solution of the embodiments of the present disclosure more clearly, the following briefly introduces the accompanying drawings required in the embodiments, which are incorporated into and constitute a part of this specification. These accompanying drawings show the embodiments in line with the present disclosure, and serve to explain the technical solution of the present disclosure together with this specification. It should be understood that the following accompanying drawings illustrate only some embodiments of the present disclosure and therefore should not be considered as limiting the scope. Those of ordinary skill in the art may still derive other drawings from these accompanying drawings without creative efforts.

FIG. 1 is a structural schematic diagram of PaaS provided by an embodiment of the present disclosure;

FIG. 2 is a flow chart of a device hotplug method provided by an embodiment of the present disclosure;

FIG. 3 is a schematic diagram of an execution process of Guest OS provided by an embodiment of the present disclosure;

FIG. 4 is a schematic diagram of a process for executing a hotplug operation using a preset hotplug device provided by an embodiment of the present disclosure;

FIG. 5 is a schematic diagram of a device hotplug apparatus provided by an embodiment of the present disclosure;

FIG. 6 is a structural schematic diagram of a computer device provided by an embodiment of the present disclosure.

### DETAILED DESCRIPTION

To make the objectives, technical solutions and advantages of the present disclosure more clearly, the following clearly and completely describes the technical solutions in the embodiments of the present disclosure with reference to the accompanying drawings in the embodiments of the present disclosure. Apparently, the described embodiments are merely a part rather than all of the embodiments of the present disclosure. The components of the embodiments of the present disclosure generally described and illustrated herein can be arranged and designed in a variety of different configurations. Therefore, the following detailed description of the embodiments of the present disclosure is not intended to limit the claimed scope of the present disclosure, but merely represents selected embodiments of the present disclosure. All other embodiments obtained by those of ordinary skill in the art based on the embodiments of the present disclosure without creative efforts shall fall within the scope of protection of the present disclosure.

The terms “first” and “second” in the specification and claims in the embodiments of the present disclosure and the above accompanying drawings are used to distinguish different objects, rather than describing a particular order or precedence. It should be understood that the data used in this way can be interchanged under appropriate circumstances, so that the embodiments described herein can be implemented in other orders than those illustrated or described herein.

As used herein, “multiple or several” refers to two or more. “And/or”, which describes the relationship of related objects, means that there may be three types of relationships, for example, A and/or B, which may indicate that A exists alone, A and B exist together, and B exists alone. The character “/” generally indicates that the context objects are in an “or” relationship.

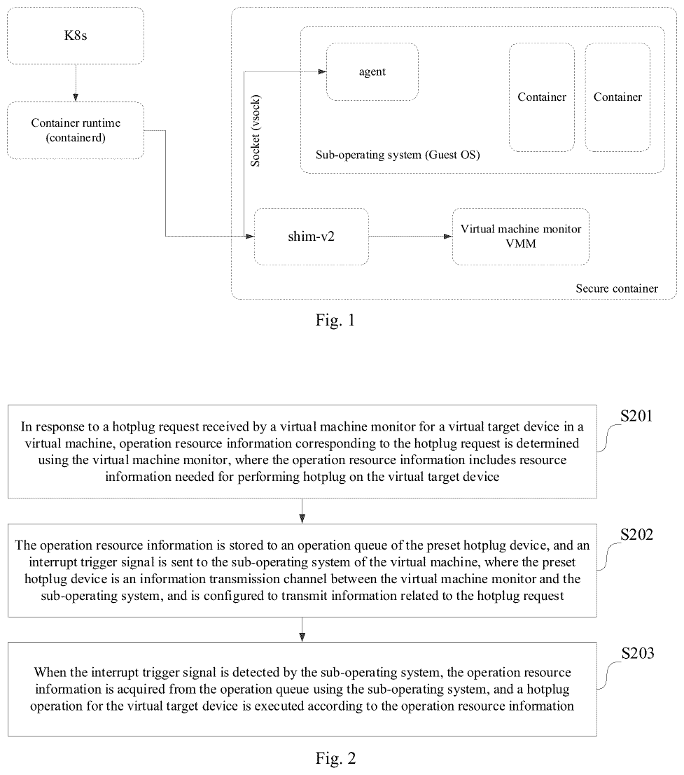

It is found through research that, as shown in FIG. 1 which is a structural schematic diagram of PaaS according to an embodiment of the present disclosure, a K8s component, a container runtime (containerd) component, and a secure container are included. The secure container includes a shim-v2 component, a VMM, and a sub-operating system (Guest OS). The Guest OS includes an agent, and multiple containers. K8s, full name of kubernetes, is an open source, which is configured to manage containerized applications on multiple hosts in a cloud platform. Container runtime (containerd) is configured to receive a request from K8s, and to convert and translate the request into a request capable of being received by shim-v2 in the secure container. shim-v2 can perform format conversion on the received request to obtain a request capable of being received by the VMM, and meanwhile, the shim-V2 may also communicate with the agent in the sub-operating system (Guest OS) based on socket (vsock). The VMM is configured to send a received request to the Guest OS to achieve the response to the request, and the container in the Guest OS is configured to run an application. ACPI, as a complex subsystem, not only can be responsible for describing various pieces of configuration information of the system, such as, the topology of a central processing unit, the topology of Non Uniform Memory Access (NUMA), Advanced Programmable Interrupt Controller (APIC), etc., but also can define a calling interface between an operating system and firmware (e.g., a Basic Input Output System (bios)). For a hotplug solution of a PaaS secure container shown in FIG. 1, it is necessary to introduce an ACPI subsystem into both the VMM and the sub-operating system. However, the introduction of the sub-operating system may lead to the problems of complicated information and large number of lines of implemented code, which not only slows down startup speed of the VMM and the sub-operating system and affects the startup speed of a virtual machine, but also greatly increases the number of codes in the VMM and the sub-operating system, increases the risk that the VMM and the sub-operating system are invaded, and affects operation safety of the virtual machine.

Based on the research above, a device hotplug method and apparatus, a computer device and a storage medium are provided by the embodiment of the present disclosure. After receiving a hotplug request, operation resource information required by the hotplug request can be accurately determined using a VMM, and a sub-operating system can be informed in time in a manner of sending the operation resource information to an operation queue corresponding to a developed preset hotplug device and then sending an interrupt trigger signal. Then, the operation resource information can be acquired from the operation queue using the sub-operating system, and hotplug for a virtual target device in a virtual machine can be achieved according to the operation resource information. The whole hotplug process can be achieved by the VMM and the sub-operating system based on the preset hotplug device and the operation queue without using an ACPI mechanism and a PCI mechanism. Because the implementation of the preset hot-plug device is lighter than the ACPI mechanism and the PCI mechanism, hotplug by the preset hot-plug device can effectively reduce the implementation number of lines of code. The reduction of the lines of code not only can effectively avoid the problem of slowing down the startup speed of the virtual machine, but also can greatly reduce the possibility that the VMM and the sub-operating system are invaded, thus reducing running risk of the virtual machine, and improving running security of the virtual machine.

The shortcomings of the above schemes are all the results obtained by the inventor after practice and careful study. Therefore, the discovery process of the above problems and the solutions proposed in the present disclosure below should be the contributions made by the inventor to the present disclosure in the process of the present disclosure.

It should be noted that similar symbols and letters indicate similar items in the following drawings, so, a certain item, once defined in one accompanying drawing, does not need to be defined and explained preferentially in subsequent accompanying drawings.

It may be understood that before using the technical solutions disclosed in various embodiments of the present disclosure, the user should be informed of the types, scope of use, use scenarios, etc. of personal information involved in the present disclosure in an appropriate way according to relevant laws and regulations, and the authorization of the user should be obtained.

It should be noted that specific nouns according to the embodiments of the present disclosure include:
MMIO: Memory-mapped I/O, i.e., memory mapped I/O;
Rust is a system programming language, which focuses on security, especially concurrent security, and supports multi-paradigm languages, such as functional, imperative, and generic paradigms;
used ring is an instruction for indicating the completion of information storage in the operation queue;
available ring is an instruction for reading information from the operation queue corresponding to the VMM.

In order to facilitate the understanding of this embodiment, firstly, a device hotplug method disclosed in this embodiment of the present disclosure is introduced in detail. An executive subject of the device hotplug method provided by the embodiment of the present disclosure is generally a terminal device or other processing devices with certain computing power, in which the terminal device may be user equipment (UE), a mobile device, a user terminal, a terminal, a personal digital assistant (PDA), a handheld device, a computer device, etc. In some possible implementations, the device hotplug method may be achieved by calling a computer readable instruction stored in a memory by a processor.

Taking a server being the executive subject as an example, the device hotplug method provided by the embodiment of the present disclosure will be described below.

FIG. 2 is a flow chart of a device hotplug method provided by an embodiment of the present disclosure. The method may include the following steps:

S201. In response to a hotplug request received by a virtual machine monitor for a virtual target device in a virtual machine, operation resource information corresponding to the hotplug request is determined using the virtual machine monitor, where the operation resource information includes resource information needed for performing hotplug on the virtual target device.

Here, the virtual target device may be a virtualized device running in the virtual machine, specifically including a virtual central processing unit (vcpu), and various virtualized mapping I/O devices (virtio mmio device). The virtio mmio device may, for example, include a virtual block (virtio-blk), a virtual user block (virtio-blk), a virtual network (virtio-net), a virtual user network (virtio-user-net), and other devices.

The hotplug request is a request for requesting to perform hotplug on any virtual target device in the virtual machine. The hotplug may be understood to perform plug-in/out on the virtual target device in the virtual machine without affecting the normal running of the virtual machine. The hotplug request may include a virtual target device needing hotplug, and an operation type of a hotplug operation needing to be executed. The operation type may include a hotplug-in operation type, and a hotplug-out operation type.

The operation resource information is resource information prepared by the VMM and related to the virtual target device, including all pieces of resource information needing to be used when performing hotplug on the virtual target device. The operation resource information can be used in the process of executing the hotplug operation, thus completing the hotplug of the device. The operation resource information may, for example, include an interrupt resource, an address resource of the virtual target device, the number of the virtual target devices, a length of the virtual target device, etc.

The VMM may be configured to process all functions of the virtual machine in the secure container, and the core is to ensure the safe operation of the virtual machine. During specific implementation, the virtual machine monitor VMM provided by the embodiment of the present disclosure is VMM developed using rust language, expressed by rust-vmm based VMM. The VMM can achieve a back-end operation of the preset hotplug device on the basis of having all functions of the traditional VMM. The preset hotplug device will be introduced in detail later.

During specific implementation, the rust-vmm based VMM, after receiving the hotpug request for the virtual target device in the virtual machine, may make response to the hotplug request. The rust-vmm based VMM is configured to dynamically prepare operation resource information related to the hotplug request according to the virtual target device and the operation type indicated by the hotplug request.

In an embodiment, the hotplug request for the virtual target device in the virtual machine can be received according to the following steps:

Step one. A container request for a secure container is received, where the container request is used to instruct to execute the hotplug operation on the virtual target device in a virtual machine in the secure container.

Here, the container request can manage a request initiated by an administrator user of each container in K8s, which is configured to instruct to execute a hotplug-in operation or a hotplug-out operation on a running virtual target device of the virtual machine in the secure container. Exemplary, the container request may be a request initiated using the K8s component shown in FIG. 1.

During specific implementation, when there is a hotplug demand for a certain virtual target device in the virtual machine, the administrator can initiate a container request for the secure container using the K8s component, and then the server can receive the container request.

Step two. The container request is converted into the hotplug request matched with the virtual machine monitor.

During specific implementation, the container runtime (containerd) component can be used to first convert the container request into a request to be processed, which can be processed by the shim-v2 component, and to send the request to be processed to the shim-v2 component. Afterwards, the shim-v2 component can be used to perform format conversion on the request to be processed, thus obtaining a hotplug request capable of being identified and processed by the rust-vmm based VMM.

Step three. A target interface related to the virtual target device is determined from multiple application programming interfaces developed for the virtual machine monitor, and the target interface is called to send the hotplug request to the virtual machine monitor.

Here, corresponding application programming interfaces (API) can be developed for various types of virtualized devices in the rust-vmm based VMM in advance, respectively. For example, corresponding APIs can be developed for virtio-blk, virtio-user-blk, virtio-net, virtual CPU and virtio-user-net in the rust-vmm Based VMM, respectively. Different APIs are used to configure corresponding hotplug requests and operation resource information of corresponding virtualized devices.

During specific implementation, the target API related to the virtual target device can be determined from multiple APIs developed for the rust-vmm based VMM, and then the hotplug request can be sent to the rust-vmm based VMM by calling the target API.

Further, after sending the hotplug request to the rust-vmm based VMM using the target API, the rust-vmm based VMM can be used to determine the operation resource information according to the following steps:

S1. Communication connection with the virtual target device is established, and a resource feature structure supported by the virtual target device is determined using the communication connection.

Here, the communication connection may be socket connection, the resource feature structure is configured to characterize virtualized feature structures (virtio features) supported by both virtual target device and rust-vmm based VMM.

During specific implementation, the rust-vmm based VMM can be used to call the target API, and the communication connection with the virtual target device is established using the function provided by the target API. Afterwards, the communication connection can be used to negotiate the resource feature structures supported by both the rust-vmm based VMM and virtual target device.

S2. The operation resource information for the virtual target device is configured according to the hotplug request and the resource feature structure.

During specific implementation, after the resource feature structures are obtained by negotiation, the operation resource information with the resource feature structures can be configured according to the resource feature structures as well as the virtual target device and the operation type in the hotplug request.

Exemplary, taking virtio-user-blk being virtual target device an example, the API of virtio-user-blk subjected to hotplug can be used to prepare the operation resource information. Specifically, an information format of the API may be as follows:
pub fn hotplug_in_vhu_blk_device (//hotplug virtio-user-blk device
&self,
id: String,//device identifier, string format
socket_path: String,//socket path, string format
num_queues; u32,//queue number, 32-bit unsigned integer
queue_size: u16,//queue size, 16-bit unsigned integer)
).

After the API is called using the rust-vmm based VMM, a socket connection with virtio-user-blk device can be established, then virtio features supported by both the virtio-user-blk device and rust-vmm based VMM can be obtained by negotiating using the socket connection. Afterwards, the operation resource information related to the virtio-user-blk device can be configured according to virtio features and the information format of the API. The operation resource information may include, for example, an interrupt (irp) resource, device address and length (mmio device base address and len) resource, an input-output event (ioevent), etc.

In an embodiment, prior to determining the operation resource information corresponding to the hotplug request using the rust-vmm based VMM, the method may further include the following steps:

In response to a container startup request, the secure container is started, and the virtual machine monitor and the sub-operating system are initialized.

Here, the sub-operating system can be represented as Guest OS, indicating to an operating system running in the virtual machine, which is configured to ensure that various functions of the virtual machine can run as normal. The container startup request may be a request to use a container. For example, the container request may be a request initiated by a user after triggering a control related to any function provided by the container.

During specific implementation, the secure container related to the virtual machine can be started in response to the container startup request, and meanwhile, the rust-vmm based VMM and the Guest OS in the secure container can be initialized to ensure the normal running of the rust-vmm based VMM and the Guest OS.

In the process of initializing the virtual machine monitor, the preset hotplug device deployed in the virtual machine monitor is started.

Here, the preset hogplug device is a device dedicated to perform hotplug on a virtualized device in the virtual machine, which is an information transmission channel between the virtual machine monitor and the sub-operating system and is configured to transmit information related to the hotplug request. The preset hotplug device can transmit the information related to the hot-plug request in the rust-vmm based VMM and the Guest OS without relying on ACPI and PCI, and play a role of the information transmission channel. A back end of the preset hotplug device is implemented in the rust-vmm based VMM, and a front-end driver is implemented in the Guest OS.

During specific implementation, the preset hotplug device is enabled in the process of initializing the rust-vmm based VMM, thus starting the preset hotplug device. Meanwhile, during initialization, the rust-vmm based VMM may provide each API based on the preset hotplug device, such that the API can be called by the rust-vmm based VMM at runtime to achieve the preparation of the operation resource information. For example, when the rust-vmm based VMM receives a hotplug request from shim-v2 at runtime, the target API related to the virtual target device can be called to achieve resource allocation to the virtual target device, thus obtaining the operation resource information.

S202. The operation resource information is stored to an operation queue of the preset hotplug device, and an interrupt trigger signal is sent to the sub-operating system of the virtual machine, where the preset hotplug device is an information transmission channel between the virtual machine monitor and the sub-operating system, and is configured to transmit information related to the hotplug request.

Here, the interrupt trigger signal is configured to inform the Guest OS that there is a hotplug request at present, and there is a need to acquire the operation resource information from the operation queue in an interrupt manner, so as to execute the hotplug operation. The operation queue is a message queue provided for the preset hotplug device, and is configured to store the operation resource information related to each hotplug request.

During specific implementation, the rust-vmm based VMM, after preparing the operation resource information, can store the operation resource information to the operation queue using the called API related to the virtual target device. After the operation resource information is stored to the operation queue, the rust-vmm based VMM can indicate the completion of storage by writing used ring.

Alternatively, in order to ensure that the Guest OS can identify and understand the operation resource information after acquiring the same, the operation resource information may also be stored according to a preset element format in the process of storing the operation resource information to the operation queue. As shown below, the element format in an operation queue provided by the embodiment of the present disclosure is shown as follows:

The element format in the operation queue is as follows:
struct HpInfo//structured hotplug information
type: hotplug for cpu or device or mem//the type of hotplug device (i.e., virtual target device), including virtual CPU, virtio mmio device, or virtual memory
plug_in_out: true for plug in, false for plug out//operation type, whether hotplug-in operation, or hotplug-out operation
base: device mmio base addr//address information of hotplug device
size: device mmio len//length information of hotplug device
irq: device irq//interrupt information of hotplug device

When the virtual target device is the virtual CPU, information indicated by the element format may include information of the number of devices.

In an embodiment, operation resource information corresponding to different types of virtual target devices has different information types. Specifically, when the virtual target device includes a virtual central processing unit in the virtual machine, the operation resource information may include the number count of virtual central processing units, and an operation type of hotplug operation. When the virtual target device includes any virtual device in the virtual machine (i.e., various virtualized mapping I/O devices (virtio mmio device)), the operation resource information includes address information of the virtual device, length information corresponding to the virtual device, interrupt information corresponding to the virtual device, and the operation type of the hotplug operation.

After storing the operation resource information to the operation queue, an interrupt trigger signal or an interrupt request can be sent to the Guest OS through the preset hotplug device, thus informing the Guest OS that the hotplug request is currently stored.

Before sending the interrupt trigger signal or interrupt request to the Guest OS, the hotplug device needs to be initialized. Specifically, the time to initialize the hotplug device can be the same as the time to initialize the rust-vmm based VMM. Specifically, the Guest OS can be initialized according to the following steps:
a hot-plug thread of the sub-operating system is started, and the hot-plug thread is set to a dormant state.

Here, the hotplug thread is used to perform the hotplug thread on the virtual device in the virtual machine, runs in the Guest OS, and is a pre-developed linux kernel thread.

During specific implementation, when making response to the container startup request, the Guest OS can be started. A mmio subsystem is used to detect whether there is a preset hot-plug device that is started, that is, whether there is a channel for transmitting information related to the hotplug request. If there is no channel for transmitting information related to the hotplug request, it is indicated that there is no preset hotplug device at present, and abnormal information can be fed back. If there is a channel for transmitting information related to the hotplug request, it is ensured that when the interrupt trigger signal or interrupt request is detected, a driver corresponding to the preset hotplug device can be used to acquire the operation resource information in the operation queue. Meanwhile, when there is a preset hot-plug device that is started, the hotplug thread in the Guest OS can be started, and the hotplug thread can be set to a dormant state when the startup of the hotplug thread is completed. By setting the hotplug thread to the dormant state, the resource consumption of the hotplug thread can be reduced when there is no hot-plug request.

Meanwhile, a trigger mechanism for the hotplug thread can be set. The trigger mechanism is used to awake the hotplug thread in the dormant state when the interrupt trigger signal or interrupt request is detected. The hotplug thread is used to execute the hotplug operation for the virtual target device according to the operation resource information.

During specific implementation, the trigger mechanism can be implemented using an interrupt callback function set for the hotplug thread. Specifically, when the hotplug thread is set to the dormant state, an interrupt callback function related to the hotplug thread may also be set. By setting the interrupt callback function, when the interrupt trigger signal or interrupt request from the rust-vmm based VMM is detected, the hotplug thread in the dormant state can be awaken, and the hotplug thread is used to execute a specific hotplug operation according to the operation resource information.

S203. When the interrupt trigger signal is detected by the sub-operating system, the operation resource information is acquired from the operation queue using the sub-operating system, and a hotplug operation for the virtual target device is executed according to the operation resource information.

During specific implementation, an interrupt monitor thread can be set in the Guest OS. When the thread monitors the interrupt trigger signal or interrupt request from the rust-vmm based VMM, that is, it can be determined that the Guest has detected the interrupt trigger signal or interrupt request, and then the operation resource information can be acquired from the operation queue using the driver corresponding to the preset hotplug device. For example, the operation resource information related to the hotplug request can be acquired from the operation queue in a manner of reading available ring using the driver.

Meanwhile, when the interrupt trigger signal or the interrupt request is detected, the hotplug thread in the dormant state can be awaken in response to triggering the trigger mechanism for the hotplug thread. After acquiring the operation resource information, the hotplug thread can be used to parse the operation resource information, and the hotplug operation for the virtual target device is executed according to a parsing result, thus achieving the hotplug for the virtual target device in the virtual machine.

In an embodiment, the step of “executing the hotplug operation for the virtual target device according to the operation resource information” can be implemented according to the following steps:
determining an operation logic according to the operation type indicated by the operation resource information and the device type of the virtual target device; and executing the hotplug operation corresponding to the operation type for the virtual target device according to the operation logic and the operation resource information.

Here, the operation type is a hotplug-in operation type, or a hotplug-out operation type. The device type may be a CPU type, or mmio device type. Different operation types correspond to different operation logics, and different device types correspond to different operation logics, and various operation logics can be preset.

During specific implementation, the hotplug thread can be used to determine the device type of the virtual target device and the operation type of the hotplug operation to be executed according to the operation resource information. Then, an operation logic of a target operation corresponding to the operation type can be determined according to the determined operation type and device type.

According to the operation logic and the operation resource information, the hotplug-in operation or hotplug-out operation can be executed for the virtual target device. For example, when the virtual target device is vcpu, according to the operation logic corresponding to the vcpu and the number in the operation resource information, the hotplug-in operation or hotplug-out operation can be executed for the vcpu. When the virtual target device is virtio mmio device, according to the operation logic corresponding to the virtio mmio device and the length information, interrupt information, address information and the like in the operation resource information, the hotplug-in operation or hotplug-out operation can be executed for the virtio mmio device.

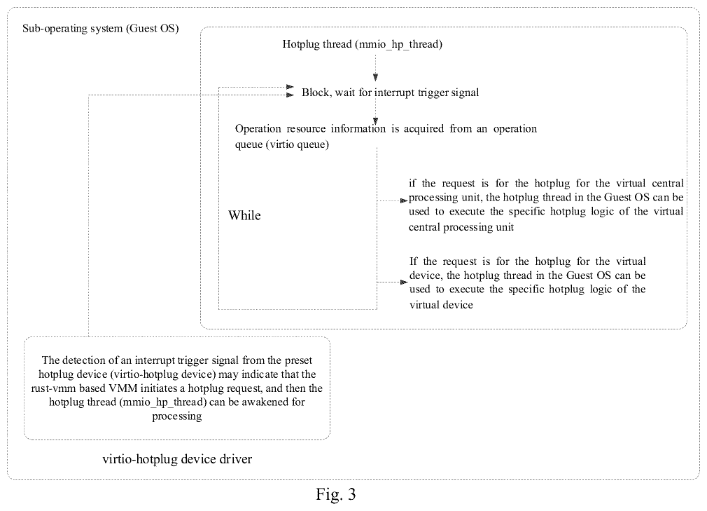

FIG. 3 is a schematic diagram of an execution process of a Guest OS provided by an embodiment of the present disclosure. The detection of an interrupt trigger signal from the preset hotplug device (virtio-hotplug device) may indicate that the rust-vmm based VMM initiates a hotplug request, and then the hotplug thread (mmio_hp_thread) can be awakened for processing. After the hotplug thread is awaken, the operation resource information can be acquired from the operation queue (virtio queue) using a driver corresponding to the preset hotplug device. Afterwards, if the request is for the hotplug for the virtual central processing unit, the hotplug thread in the Guest OS can be used to execute the specific hotplug logic of the virtual central processing unit according to the acquired operation resource information. If the request is for the hotplug for the virtual device, the hotplug thread in the Guest OS can be used to execute the specific hotplug logic of the virtual device according to the acquired operation resource information.

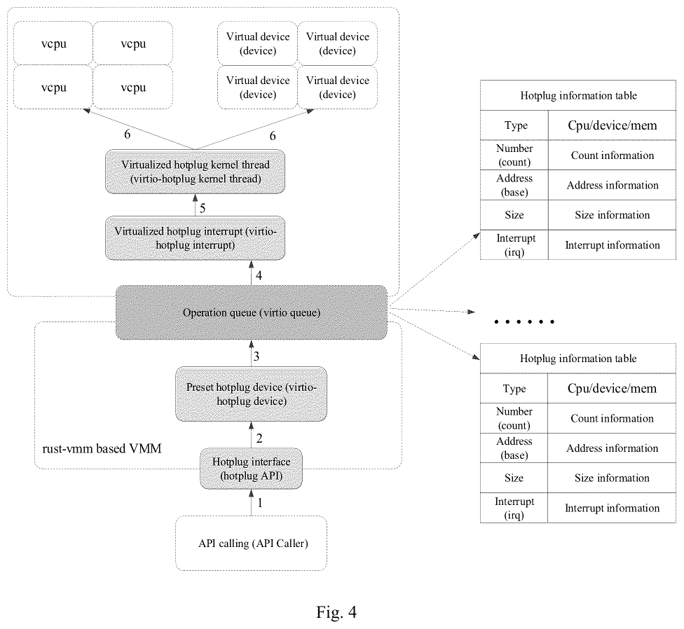

FIG. 4 is a schematic diagram showing the process of executing a hotplug operation using a preset hotplug device provided by an embodiment of the present disclosure. API Caller indicates API calling, and the specific hotplug process may include: 1. shim-v2 may call any one of multiple application programming interfaces (i.e., the hotplug API in FIG. 4) developed based on the preset hotplug device (virtio-hotplug device) through API Caller, and send a hotplug request to rust-vmm based VMM. 2. The rust-vmm based VMM can prepare the operation resource information through the virtio-hotplug device using the called hotplug ASI. 3. The rust-vmm based can send the operation resource information to the operation queue (vitrio queue), and the operation resource information can be stored according to a preset element format in the virtio queue. As shown in FIG. 4, two hotplug information tables are shown. The operation resource information stored according to the present element format is shown in the hotplug information table, and the operation resource information about the others is not shown one by one, and is identified by ellipsis in FIG. 4. One hotplug information table corresponds to the operation resource information of one hotplug request. When the virtual target device needing hotplug is a cpu type, the table can only include type information and count information. When the virtual target device needing hotplug is a mmio device type, the table may only include type information, address information, size information, and interrupt information. The type is the device type, which may include the cpu type, the device type (i.e., mmio device type), and memory (i.e., mem) type. 4. After the operation resource information is stored in the operation queue, sending an interrupt trigger signal (i.e., virtualized hotplug interrupt (virtio-hotplug interrupt) in FIG. 4) to the Guest OS can be initiated. 5. In response to a situation that the interrupt trigger signal is detected, the hotplug thread can be awaken (i.e., a virtualized hotplug kernel thread (virtio-hotplug kernel thread) in FIG. 4). 6. The hotplug thread is used to execute the hotplug operation for the virtual target device according to the operation resource information acquired from the operation queue. In Step 6, the vcpu and the virtual device (i.e., the device in FIG. 4) in the virtual machine are pointed out, respectively. During specific implementation, the vcpu and the virtual device can be subjected to hotplug according to a specific hotplug request.

In this way, based on above embodiments, the hotplug for the virtual machines can be achieved using the rust-vmm based VMM and the sub-operating system based on a lightweight preset hotplug device and the operation queue without using an ACPI mechanism and a PCI mechanism. Because the implementation of the preset hot-plug device is lighter than the ACPI mechanism and the PCI mechanism, hotplug by the preset hot-plug device can effectively reduce the implementation number of lines of code. The reduction of the lines of code not only can effectively avoid the problem of slowing down the startup speed of the virtual machine, but also can greatly reduce the possibility that the VMM and the sub-operating system are invaded, thus reducing running risk of the virtual machine, and improving running security of the virtual machine.

It may be understood by those skilled in the art that in the above method of the specific embodiments, the writing order of various steps does not mean strict execution order and constitutes any limitation on the implementation process, and the specific execution order of various steps should be determined according to functions and possible internal logics thereof.

Based on the same inventive concept, an embodiment of the present disclosure also provides a device hotplug apparatus corresponding to a device hotplug method. Since the principle of solving problems by the apparatus in the embodiment of the present disclosure is similar to the device hotplug method in the embodiment of the present disclosure, the implementation of the apparatus may refer to the implementation of the method, and thus will not be described in detail here.

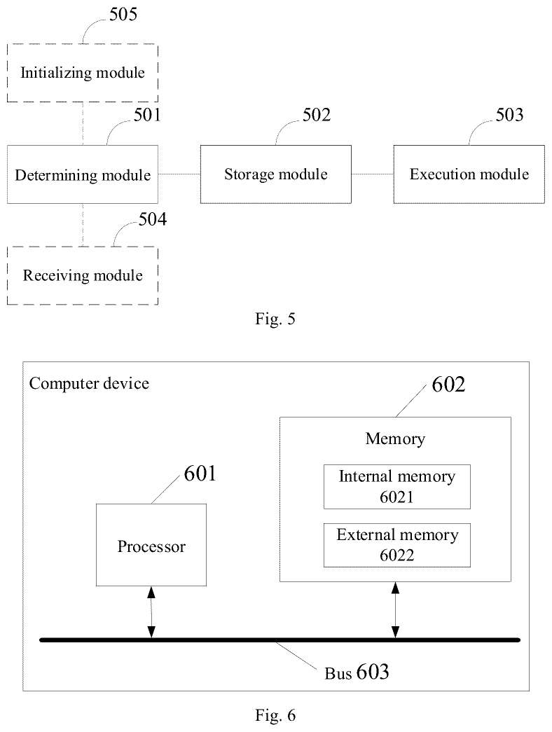

FIG. 5 is a schematic diagram of a device hotplug apparatus provided by an embodiment of the present disclosure is provided. The apparatus includes a determining module 501, a storage module 502 and an execution module 503,
the determining module 501 is used for, in response to a hotplug request received by a virtual machine monitor for a virtual target device in a virtual machine, determining operation resource information corresponding to the hotplug request using the virtual machine monitor, wherein the operation resource information includes resource information needed for performing hotplug on the virtual target device;
the storage module 502 is used for storing the operation resource information into an operation queue of a preset hotplug device, and sending an interrupt trigger signal to a sub-operating system of the virtual machine, wherein the preset hotplug device is an information transmission channel between the virtual machine monitor and the sub-operating system, and is configured to transmit information related to the hotplug request; and
the execution module 503 is used for acquiring the operation resource information from the operation queue by using the sub-operating system when the interrupt trigger signal is detected by the sub-operating system, and executing a hotplug operation for the virtual target device according to the operation resource information.

In one possible implementation, the apparatus further includes a receiving module 504, where the receiving module 504 is used for receiving the hotplug request for a virtual target device in a virtual machine includes:
receiving a container request for a secure container, wherein the container request is used to instruct to execute the hotplug operation on the virtual target device in a virtual machine in the secure container;
converting the container request into the hotplug request matched with the virtual machine monitor; and
determining a target interface related to the virtual target device from a plurality of application programming interfaces developed for the virtual machine monitor, and calling the target interface to send the hotplug request to the virtual machine monitor.

In one possible implementation, the determining module 501, when determining operation resource information corresponding to the hotplug request using the virtual machine monitor, is used for:
establishing communication connection with the virtual target device, and determining a resource feature structure supported by the virtual target device using the communication connection; and
configuring the operation resource information for the virtual target device according to the hotplug request and the resource feature structure.

In one possible implementation, the apparatus further includes an initializing module 505, where the initializing module 505, prior to determining operation resource information corresponding to the hotplug request using the virtual machine monitor, the method further, is used for:
starting the secure container in response to a container startup request, and initializing the virtual machine monitor and the sub-operating system; and
starting the preset hotplug device deployed in the virtual machine monitor in a process of initializing the virtual machine monitor.

In one possible implementation, the initializing module 505, when initializing the sub-operating system, is used for:
starting a hotplug thread of the sub-operating system and setting the hot-plug thread to a dormant state;
setting a trigger mechanism for the hotplug thread, wherein the trigger mechanism is used to awake the hotplug thread in the dormant state when the interrupt trigger signal is detected, and the hotplug thread is used to execute the hotplug operation for the virtual target device according to the operation resource information.

In one possible implementation, when the virtual target device includes a virtual central processing unit in the virtual machine, the operation resource information includes a number of the virtual central processing units and an operation type of the hotplug operation; and

when the virtual target device includes any virtual device in the virtual machine, the operation resource information includes address information of the virtual device, length information corresponding to the virtual device, interrupt information corresponding to the virtual device, and the operation type of the hotplug operation.

In one possible implementation, the execution module 503, when executing a hotplug operation for the virtual target device according to the operation resource information, is used for:
determining operation logic according to an operation type indicated by the operation resource information and a device type of the virtual target device; and
executing the hotplug operation corresponding to the operation type for the virtual target device according to the operation logic and the operation resource information.

The description of the processing flow of each module in the apparatus and the interactive flow between modules can refer to the relevant description in the above method embodiment, and thus will not be described in detail here.

Based on the same technical concept, an embodiment of the present disclosure also provides a computer device. FIG. 6 is a structural schematic diagram of a computer device provided by an embodiment of the present disclosure. The computer device includes:
a processor 601, a memory 602, and a bus 603. A machine readable instruction capable of being executed by the processor 601 is stored in the memory 602, the processor 601 is configured to execute the machine readable instruction stored in the memory 602. The machine readable instruction, when executed by the processor 601, is configured to execute the following steps: S201: in response to a hotplug request received by a virtual machine monitor for a virtual target device in a virtual machine, determining operation resource information corresponding to the hotplug request using the virtual machine monitor, wherein the operation resource information includes resource information needed for performing hotplug on the virtual target device; S202: storing the operation resource information into an operation queue of a preset hotplug device, and sending an interrupt trigger signal to a sub-operating system of the virtual machine, where the preset hotplug device is an information transmission channel between the virtual machine monitor and the sub-operating system, and is configured to transmit information related to the hotplug request; and S203: acquiring the operation resource information from the operation queue by using the sub-operating system when the interrupt trigger signal is detected by the sub-operating system, and executing a hotplug operation for the virtual target device according to the operation resource information.

The memory 602 includes an internal memory 6021, and an external memory 6022. The internal memory 6021 is configured to temporarily store the operation data in the processor 601 and the data exchanged with the external memory 6022 such as a hard disk. The processor 601 exchanges data with the external memory 6022 through the internal memory 6021. When the computer device is in running, the processor 601 communicates with the memory 602 through the bus 603, such that the processor 601 can execute an execution instruction mentioned in the above method embodiment.

A computer readable storage medium is further provided by an embodiment of the present disclosure, and a computer program is stored on the computer readable storage medium. The computer program, when executed by a processor, can execute the steps of the device hotplug method of the above method embodiment. The storage medium may be a volatile or nonvolatile computer readable storage medium.

A computer program product of the device hotplug method provided by the embodiment of the present disclosure includes a computer-readable storage medium in which program codes are stored, and the program codes include instructions that can be used to execute the steps of the device hotplug method described in the embodiment of the above method. The details may refer to the embodiment of the above method, and thus will not be described in detail here.

The computer program product may be implemented in hardware, software or a combination thereof. In an alternative embodiment, the computer program product is specifically embodied in a computer storage medium, and in another alternative embodiment, the computer program product is specifically embodied in a software product, such as a Software Development Kit (SDK) and the like.

It can be clearly understood by those skilled in the art that for the convenience and conciseness of description, the specific working process of the system and apparatus described above may refer to the corresponding process in the aforementioned method embodiment, and thus will not be described in detail here. In some embodiments provided by the present disclosure, it should be understood that the system, apparatus and method disclosed here may be implemented in other ways. The apparatus embodiments described above are only schematic. For example, the division of the units is only a logical function division, and there may be another division method in actual implementation. For example, multiple units or components may be combined or integrated into another system, or some features may be ignored or not implemented. On the other hand, the mutual coupling or direct coupling or communication connection shown or discussed may be indirect coupling or communication connection through some communication interfaces, apparatuses or units, which may be in electrical, mechanical or other forms.

The units described as separating components may or may not be physically separated, and the components displayed as modules may or may not be physical units, that is, they may be located in one place, or may be distributed to multiple network units. A part or all of the units can be selected according to actual needs to implement the purpose of the scheme of this embodiment.

Various functional units in each embodiment of the present disclosure may be integrated into one processing unit, each unit may exist separately physically, or two or more units may be integrated into one unit.

If the functions are realized in the form of software functional units and sold or used as independent products, they can be stored in a processor-executable nonvolatile computer-readable storage medium. Based on such an understanding, the essence of the technical solution of the present disclosure, or the part contributing to the prior art, may be implemented in the form of a software product. The computer software product is stored in a storage medium, and includes several instructions for indicating one computer device (which may be a personal computer, a server, or a network device) to execute all or some of the steps of the method described in the embodiments of the present disclosure. The aforementioned storage media include: a U disk, a mobile hard disk, a read-only memory (ROM), a random-access memory (RAM), a magnetic disk or an optical disk, and other media capable of storing program codes.

If the technical solution of the present application involves personal information, before processing the personal information, the products applying the technical solution of the present application have clearly informed the personal information processing rules and obtained personal independent consent. If the technical solution of the present disclosure involves sensitive personal information, before processing the sensitive personal information, the products applying the technical solution of the present application have obtained individual's separate consent, and meet the requirements of “explicit consent” at the same time. For example, at a personal information collection apparatus, such as a camera, explicit and remarkable reminders should be installed to inform that it has entered the scope of personal information collection, and personal information will be collected. Individuals voluntarily entering the collection scope shall be deemed as agreeing to collect their personal information. Otherwise, on a personal information processing apparatus, when informing the personal information processing rules with explicit identifiers/information, the personal authorization is obtained by pop-up information or asking individuals to upload their personal information by themselves. The rules for personal information processing may include personal information processors, personal information processing purposes, processing means, types of personal information processed and other information.

Finally, it should be noted that the foregoing embodiments are specific embodiments of the present disclosure, which are used to illustrate the technical solution of the present disclosure, rather than limiting. The scope of protection of the present disclosure is not limited to thereto. Although the present disclosure has been described in detail with reference to the foregoing embodiments, those of ordinary skill in the art should understand that any skilled person familiar with the present technical field may still modify the technical solutions described by the above embodiments or readily envisage variations or replace part of the technical features therein with equivalents within the technical scope disclosed by the disclosure. Such modifications, variations or replacements should not depart the respective technical solutions from the spirit and scope of the technical solutions described by the embodiments of the present disclosure, and shall be encompassed by the scope of protection of the present disclosure. Therefore, the scope of protection of the present disclosure is subject to that defined by the claims.

What is claimed is:

1. A device hotplug method, comprising:
in response to a hotplug request received by a virtual machine monitor for a virtual target device in a virtual machine, determining operation resource information corresponding to the hotplug request using the virtual machine monitor, wherein the operation resource information comprises resource information needed for performing hotplug on the virtual target device;
storing the operation resource information into an operation queue of a preset hotplug device, and sending an interrupt trigger signal to a sub-operating system of the virtual machine, wherein the preset hotplug device is an information transmission channel between the virtual machine monitor and the sub-operating system, and is configured to transmit information related to the hotplug request; and
acquiring the operation resource information from the operation queue by using the sub-operating system when the interrupt trigger signal is detected by the sub-operating system, and executing a hotplug operation for the virtual target device according to the operation resource information.

2. The method according to claim 1, wherein receiving the hotplug request for a virtual target device in a virtual machine comprises:
receiving a container request for a secure container, wherein the container request is used to instruct to execute the hotplug operation on the virtual target device in a virtual machine in the secure container;
converting the container request into the hotplug request matched with the virtual machine monitor; and
determining a target interface related to the virtual target device from a plurality of application programming interfaces developed for the virtual machine monitor, and calling the target interface to send the hotplug request to the virtual machine monitor.

3. The method according to claim 1, wherein the determining operation resource information corresponding to the hotplug request using the virtual machine monitor comprises:
establishing communication connection with the virtual target device, and determining a resource feature structure supported by the virtual target device using the communication connection; and
configuring the operation resource information for the virtual target device according to the hotplug request and the resource feature structure.

4. The method according to claim 1, wherein prior to determining operation resource information corresponding to the hotplug request using the virtual machine monitor, the method further comprises:
starting the secure container in response to a container startup request, and initializing the virtual machine monitor and the sub-operating system; and
starting the preset hotplug device deployed in the virtual machine monitor in a process of initializing the virtual machine monitor.

5. The method according to claim 4, wherein initializing the sub-operating system comprises:
starting a hotplug thread of the sub-operating system and setting the hot-plug thread to a dormant state;
setting a trigger mechanism for the hotplug thread, wherein the trigger mechanism is used to awake the hotplug thread in the dormant state when the interrupt trigger signal is detected, and the hotplug thread is used to execute the hotplug operation for the virtual target device according to the operation resource information.

6. The method according to claim 1, wherein when the virtual target device comprises a virtual central processing unit in the virtual machine, the operation resource information comprises a number of the virtual central processing units and an operation type of the hotplug operation; and
when the virtual target device comprises any virtual device in the virtual machine, the operation resource information comprises address information of the virtual device, length information corresponding to the virtual device, interrupt information corresponding to the virtual device, and the operation type of the hotplug operation.

7. The method according to claim 1, wherein the executing a hotplug operation for the virtual target device according to the operation resource information comprises:
determining operation logic according to an operation type indicated by the operation resource information and a device type of the virtual target device; and
executing the hotplug operation corresponding to the operation type for the virtual target device according to the operation logic and the operation resource information.

8. A computer device, comprising at least one processor, and at least one memory, wherein a machine readable instruction capable of being executed by the at least one processor is stored in the at least one memory, the at least one processor is configured to execute the machine readable instruction stored in the at least one memory, and when the machine readable instruction is executed by the at least one processor, the at least one processor executes a device hotplug method, the method comprises:
in response to a hotplug request received by a virtual machine monitor for a virtual target device in a virtual machine, determining operation resource information corresponding to the hotplug request using the virtual machine monitor, wherein the operation resource information comprises resource information needed for performing hotplug on the virtual target device;
storing the operation resource information into an operation queue of a preset hotplug device, and sending an interrupt trigger signal to a sub-operating system of the virtual machine, wherein the preset hotplug device is an information transmission channel between the virtual machine monitor and the sub-operating system, and is configured to transmit information related to the hotplug request; and
acquiring the operation resource information from the operation queue by using the sub-operating system when the interrupt trigger signal is detected by the sub-operating system, and executing a hotplug operation for the virtual target device according to the operation resource information.

9. The computer device according to claim 8, wherein receiving the hotplug request for a virtual target device in a virtual machine comprises:
receiving a container request for a secure container, wherein the container request is used to instruct to execute the hotplug operation on the virtual target device in a virtual machine in the secure container;
converting the container request into the hotplug request matched with the virtual machine monitor; and
determining a target interface related to the virtual target device from a plurality of application programming interfaces developed for the virtual machine monitor, and calling the target interface to send the hotplug request to the virtual machine monitor.

10. The computer device according to claim 8, wherein the determining operation resource information corresponding to the hotplug request using the virtual machine monitor comprises:
establishing communication connection with the virtual target device, and determining a resource feature structure supported by the virtual target device using the communication connection; and
configuring the operation resource information for the virtual target device according to the hotplug request and the resource feature structure.

11. The computer device according to claim 8, wherein prior to determining operation resource information corresponding to the hotplug request using the virtual machine monitor, the method further comprises:
starting the secure container in response to a container startup request, and initializing the virtual machine monitor and the sub-operating system; and
starting the preset hotplug device deployed in the virtual machine monitor in a process of initializing the virtual machine monitor.

12. The computer device according to claim 11, wherein initializing the sub-operating system comprises:
starting a hotplug thread of the sub-operating system and setting the hot-plug thread to a dormant state;
setting a trigger mechanism for the hotplug thread, wherein the trigger mechanism is used to awake the hotplug thread in the dormant state when the interrupt trigger signal is detected, and the hotplug thread is used to execute the hotplug operation for the virtual target device according to the operation resource information.

13. The computer device according to claim 8, wherein when the virtual target device comprises a virtual central processing unit in the virtual machine, the operation resource information comprises a number of the virtual central processing units and an operation type of the hotplug operation; and
when the virtual target device comprises any virtual device in the virtual machine, the operation resource information comprises address information of the virtual device, length information corresponding to the virtual device, interrupt information corresponding to the virtual device, and the operation type of the hotplug operation.

14. The computer device according to claim 8, wherein the executing a hotplug operation for the virtual target device according to the operation resource information comprises:
determining operation logic according to an operation type indicated by the operation resource information and a device type of the virtual target device; and
executing the hotplug operation corresponding to the operation type for the virtual target device according to the operation logic and the operation resource information.

15. A non-transitory computer readable storage medium, wherein a computer program is stored on the non-transitory computer readable storage medium, and when the computer program is run by a computer device, the computer device executes a device hotplug method, the method comprises:
in response to a hotplug request received by a virtual machine monitor for a virtual target device in a virtual machine, determining operation resource information corresponding to the hotplug request using the virtual machine monitor, wherein the operation resource information comprises resource information needed for performing hotplug on the virtual target device;
storing the operation resource information into an operation queue of a preset hotplug device, and sending an interrupt trigger signal to a sub-operating system of the virtual machine, wherein the preset hotplug device is an information transmission channel between the virtual machine monitor and the sub-operating system, and is configured to transmit information related to the hotplug request; and
acquiring the operation resource information from the operation queue by using the sub-operating system when the interrupt trigger signal is detected by the sub-operating system, and executing a hotplug operation for the virtual target device according to the operation resource information.

16. The non-transitory computer readable storage medium according to claim 15, wherein receiving the hotplug request for a virtual target device in a virtual machine comprises:
receiving a container request for a secure container, wherein the container request is used to instruct to execute the hotplug operation on the virtual target device in a virtual machine in the secure container;
converting the container request into the hotplug request matched with the virtual machine monitor; and
determining a target interface related to the virtual target device from a plurality of application programming interfaces developed for the virtual machine monitor, and calling the target interface to send the hotplug request to the virtual machine monitor.

17. The non-transitory computer readable storage medium according to claim 15, wherein the determining operation resource information corresponding to the hotplug request using the virtual machine monitor comprises:
establishing communication connection with the virtual target device, and determining a resource feature structure supported by the virtual target device using the communication connection; and
configuring the operation resource information for the virtual target device according to the hotplug request and the resource feature structure.

18. The non-transitory computer readable storage medium according to claim 15, wherein prior to determining operation resource information corresponding to the hotplug request using the virtual machine monitor, the method further comprises:
starting the secure container in response to a container startup request, and initializing the virtual machine monitor and the sub-operating system; and
starting the preset hotplug device deployed in the virtual machine monitor in a process of initializing the virtual machine monitor.

19. The non-transitory computer readable storage medium according to claim 18, wherein initializing the sub-operating system comprises:
starting a hotplug thread of the sub-operating system and setting the hot-plug thread to a dormant state;
setting a trigger mechanism for the hotplug thread, wherein the trigger mechanism is used to awake the hotplug thread in the dormant state when the interrupt trigger signal is detected, and the hotplug thread is used to execute the hotplug operation for the virtual target device according to the operation resource information.

20. The non-transitory computer readable storage medium according to claim 15, wherein when the virtual target device comprises a virtual central processing unit in the virtual machine, the operation resource information comprises a number of the virtual central processing units and an operation type of the hotplug operation; and
when the virtual target device comprises any virtual device in the virtual machine, the operation resource information comprises address information of the virtual device, length information corresponding to the virtual device, interrupt information corresponding to the virtual device, and the operation type of the hotplug operation.
